(19) United States
(12) Patent Application Publication
(10) Pub. No.: US 2007/0184167 A1
(43) Pub. Date: Aug. 9, 2007

(54) Preservation of flavanols or antioxidants in food products

(76) Inventors: W. Jeffrey Hurst, Hershey, PA (US); David A. Stuart, Mt. Gretna, PA (US); Linda A. Stahl, Elizabethtown, PA (US); Kenneth B. Miller, Palmyra, PA (US)

Correspondence Address: WILEY REIN LLP, 1776 K. STREET N.W., WASHINGTON, DC, 20006, US

(21) Appl. No.: 11/491,239

(22) Filed: Jul. 24, 2006

Related U.S. Application Data
(60) Provisional application No. 60/771,032, filed on Feb. 8, 2006.

(51) Int. Cl. A21D 10/00

(52) U.S. Cl. 426/549

(57) ABSTRACT

The invention provides, in one aspect, a method of making a cocoa-containing food product or ingredient and preserving the levels of a particular polyphenol compound, a collection of polyphenol compounds, and/or total polyphenols present. Certain commonly used baking methods for chocolate cakes and food products use leavening agents that create an alkaline condition that effectively degrades cocoa polyphenols. By monitoring the pH or by adjusting certain alkaline agents or leavening agents used, baked products can be prepared that preserve about 75% or more of the initial cocoa polyphenols present. Food products, cocoa-containing food products, baking mixes and kits, and baked food products produced from the methods are also disclosed.

### REFERENCE TO RELATED APPLICATIONS

This application claims priority benefit of U.S. Provisional Application 60/771,032, filed Feb. 8, 2006, the entire contents of which are hereby incorporated by reference.

### FIELD OF THE INVENTION AND INTRODUCTION

The invention relates to methods for preserving the antioxidant levels in food products and food products made from these methods. In particular, the invention relates to food products comprising a cocoa ingredient or cocoa flavanols. Use of the methods of the invention provide food products with enhanced levels of beneficial antioxidants by monitoring and/or adjusting pH levels of the ingredients that buffer or effect pH levels. In other embodiments, the invention relates specifically to baked food products comprising a cocoa ingredient or flavanol, for example as an additive or nutraceutical.

Standard techniques of processing and baking with cocoa-containing products subject the cocoa to thermal stresses and pH extremes, thereby altering and/or degrading the levels of beneficial antioxidants. The present invention describes combinations of ingredients and/or pre-baking conditions that can be used to preserve the polyphenol and antioxidant content of food products and especially baked goods.

### DESCRIPTION OF RELATED ART AND BACKGROUND TO THE INVENTION

The recent identification of polyphenol compounds known as flavanoids in chocolate spurred greater interest in cocoa products and their antioxidant mechanisms. See Lazarus S. A., et al., Chocolate contains additional flavonoids not found in tea, Lancet 20;354(9192):1825 (1999); Dreosti I. E., Antioxidant polyphenols in tea, cocoa, and wine, Nutrition 16(7-8):692-4 (2000); Lamuela-Raventos RM, et al., More antioxidants in cocoa, J Nutr. 131(3):834-5 (2001); Serafini M., et al., Plasma antioxidants from chocolate, Nature 28;424(6952):1013 (2003). Cocoa is considered a rich source of antioxidants, including the flavan-3-ols, epicatechin and catechin, and their oligomers. Interest in these flavanoids is at least in part driven by continuing reports demonstrating the wide beneficial health effects associated with the ingestion of polyphenol compounds found in cocoa. See Weisburger, J. H., Exp. Biol. Med. 226(10) 891-897 (2001); Fraga C. G., Am. J. Clin. Nutr. 81(3):541-2 (2005); Kurosawa T., et. al., Atherosclerosis, 179(2):237-46 (2005); Grassi D., et. al., Short-term administration of dark chocolate is followed by a significant increase in insulin sensitivity and a decrease in blood pressure in healthy persons, Am. J. Clin. Nutr. 81(3):611-4 (2005).

Research by the inventors has determined that the level of polyphenols in a confectionary product bears a direct relationship to the amount of cocoa in the product. Hurst, W. J., et. al., The Determination of Polyphenols and the Correlation to Cocoa Content in Selected US Confectionary Products, Functional Foods and Bioactive Compounds and Human Health, presented at Cornell University, May 2005; Miller, K. B., et al., Antioxidant Activity and Polyphenol and Procyanidin Contents of Selected Commercially Available Cocoa-Containing and Chocolate Products in the United States, J. of Agric. and Food Chem., published on web as # jf060290o by American Chemical Society May 2006 (the entire contents of these documents are specifically incorporated herein by reference). However, the current methods and processes to produce cocoa food products fail to take into account the preservation of these polyphenols. As described below, the inventors have addressed this and other short-comings in the art to provide improved food products.

### SUMMARY OF THE INVENTION

In one aspect, the invention relates to food products and methods of producing or manufacturing food products that preserve the level of antioxidants found in certain ingredients or food additives. Certain conditions, such as thermal stress and pH extremes, are reported to cause polyphenols from green tea to epimerize or degrade. See Wang, R., et al., Stability of Tea Catechins in the Breadmaking Process, J Agric. Food Chem., 52, 8224-8229 (2004); Wang, H., et al., Epimerization of Catechins in Green Tea Infusions, Food Chemistry, 70, 337-344 (2000); Chen, Z., et al., Degradation of Green Tea Catechins in Tea Drinks, J Agric. Food Chem., 49, 477-482 (2001). We have found that the currently used and standard techniques of processing and especially baking with cocoa-containing products subject the polyphenols to similar thermal stresses and pH extremes. The data below show that standard conditions can often and generally do decrease and/or degrade the levels of beneficial antioxidants from cocoa in a wide variety of baked goods. With this knowledge, we can define parameters that preserve the antioxidants and yet retain or generate pleasant-tasting or acceptable-tasting food products and especially cocoa or chocolate products and food products that can be used as ingredients or parts of other foods and confections. The commercial benefit of the invention is clear when one recognizes that the predominant flavor of baked goods such as cookies, cakes, shortbreads, doughnuts and other baked goods is chocolate or cocoa flavored. The ingredients and methods demonstrated herein provide methods for making these products and still preserve the healthful benefits of the natural antioxidants found in cocoa and chocolate.

Thus, in one embodiment, the invention describes combinations of ingredients and/or baking conditions used to preserve the polyphenol or antioxidant content of baked goods or ingredients. For baked cookies, brownies, and cakes, methods often involve the addition of leavening agents to enable the batter and the resulting baked product to rise. Rising provides a pleasing, soft texture that is associated with breads, cakes and other baked goods. It is also desirable to preserve as many nutritional and functional properties of the ingredients to maintain the overall value of the finished baked good. This is becoming increasingly important in light of the antioxidant content of cocoa and the positive health effects that can be attributed to antioxidants in foods.

In a more particular embodiment, the invention comprises a baked food product comprising cocoa or a cocoa-containing product, flour, and baking powder, wherein the level of antioxidants in the cocoa or cocoa-containing product is preserved as compared to its initial level. The invention also comprises methods of producing these baked food products. In a particular aspect of the method, the ingredients are mixed into a pre-baked mixture and the pH of the pre-baked mixture is maintained at or below 6.8, and preferably below about pH 6.6, during the period the cocoa or cocoa-containing product is present in the pre-baked mixture, sometimes referred to as batter. Various combinations of leavening agents can be used, including baking soda, so that the baked food has a pleasing texture. However, the combinations of leavening agents are selected so that the pH does not rise above 6.8, and preferably not above pH 6.6 in the batter. In other related embodiments, the method comprises monitoring the pH level in a pre-baked mixture. In another aspect, the pH of the final baked product is maintained at about pH 7.8 or below, or 7.5 or below.

Thus, the invention specifically includes methods of producing a food product comprising mixing at least one polyphenol containing ingredient with other ingredients, maintaining the pH at a desired level for the product during the time a batter mixture is used, and baking the mixed ingredients at a desired temperature to maintain a final baked product pH or about 7.8 or below, or 7.5, or 7.4 or below. In general, the invention relates to the use of anti-oxidant preserving conditions in making batters and final baked products. The antioxidant preserving conditions can differ, specifically with respect to pH conditions, depending on whether the antioxidants are present in a batter form or in a final product form. In addition, preservatives can also be added to the batter and be present in the final product to further maintain antioxidant levels.

In a particularly preferred embodiment, the polyphenol containing ingredient is a cocoa-containing food ingredient or product. A non-limiting list of the types of cocoa-containing products includes: cocoa powder, natural cocoa, dutched cocoa, cocoa extract, baking chocolate, chocolate liquor, semisweet chocolate, bittersweet chocolate, dark chocolate, and milk chocolate. Various chocolate and cocoa-containing products and compositions noted here refer to the terms as used in Minifie (Chocolate, Cocoa, and Confectionary, 3d ed., Aspen Publishers 1999), specifically incorporated herein by reference. In particular, the cacao bean refers to the cacao bean, also called cocoa bean, in nature and a cocoa containing product is a product derived from or having some component derived from the cocoa bean. The nib refers to the cacao bean without the shell and ranges from approximately 50% to 56% fat and approximately 44% to 50% non fat solids on a dry basis. Non fat cocoa solids are the processed non fat solids of chocolate liquor. Cocoa powder refers typically to cocoa solids with a total of 10% to 12% fat, where the fat is generally cocoa butter. However, other forms of cocoa powder can be made or used, and are commercially available, that are defatted further so that the fat levels range from 0% to 10% or are partially defatted such that the fat level ranges from 12% to 55% fat. The cocoa polyphenol compositions of the invention generally contain natural cocoa or cocoa powder, which is the product resulting from pressing the lipid content from fermented and roasted cacao bean nibs. Unroasted, raw, underfermented, and/or unfermented cacao beans and their extracts can be selected or used for any aspect of the invention, but unless otherwise stated, the cocoa products and extracts referred to herein are or relate to natural cocoa or natural cocoa powder that has been fermented and roasted as known in the art. Approximately 10-25% of the lipid fraction (cocoa butter) is retained in natural cocoa. Furthermore, natural cocoa and cocoa powder is not treated with alkaline conditions, processed with alkali, or subjected to other treatments known to the cocoa industry known as “Dutching,” unless it is specifically indicated as dutched, alkalized, or dutch process cocoa. Breakfast cocoa is cocoa solids with 20 to 24% fat, where the fat is generally cocoa butter. Chocolate liquor is ground cacao bean nibs, cocoa liquor or cocoa mass, the latter term used especially in Europe. Chocolate liquor can be separated into cocoa butter and cocoa solids. Cocoa butter is the fat component of chocolate liquor, whereas the remaining part of chocolate liquor is cocoa solids. As one of skill in the art understands, a certain amount or percentage of cocoa solids in a food ingredient can be achieved, inter alia, by using or adding an amount of cocoa powder, chocolate liquor, or other chocolate or cocoa ingredient containing the requisite amount of cocoa solids. Similarly, a certain amount or percentage of natural cocoa in a food ingredient can be achieved, inter alia, by using or adding an amount of cocoa powder, chocolate liquor or other chocolate or cocoa ingredient. In addition, while a cocoa containing product or extract having a particular antioxidant or polyphenol level is not required, the invention encompasses the use of one or more cocoa-containing products or extracts with enhanced, altered, or increased levels of antioxidants, procyanidins, or polyphenol compounds as compared to conventional cocoa-containing products. A variety of production methods, extraction methods, and the addition of extracts or cocoa-derived polyphenols have been mentioned and can be used by one of ordinary skill in the art to create cocoa compositions of the invention.

As noted, a variety of leavening agents can be selected or used. For example, any one or more of the following, as a non-limiting list, can be used or tested: aluminum bicarbonate, baking powder, baking soda (sodium bicarbonate), bicarbonate of soda, phosphates, calcium aluminum phosphate, potassium bicarbonate, cream of tartar, tartaric acid, malic acid, citric acid, glucono delta-lactone, and potassium carbonate. As one of skill in the art understands, a leavening agent can be produced with an alkali compound, such as sodium bicarbonate (baking soda), or with the combination of sodium bicarbonate and an acid compound, usually in the form of salt crystals, and optionally together with a starch. A number of combinations can be prepared from the list above and the compounds known or available to one of skill in the art (see Donald K. Dubois, Chemical Leavening, American Institute of Baking, Vol. 3, Issue 9. pp. 1-6. September 1981, specifically incorporated herein by reference). Furthermore, the individual components of a leavening agent can be selected to impart a pH buffering effect to the batter, for example to maintain the pH of a batter at or below 6.8, or at or below 7.0, or preferably at or below about 6.6 or 6.5, and/or to add a flavor or taste, such as with citric acid and salts thereof. Similarly, the baked food product of any aspect of the invention can be made that has a desired pH range or maintains or pH at or below a desired level, preferably at or below pH 7.8, or at or below 7.5, or at or below pH 7.2 or 7.1. For example, the invention specifically includes a baked food product, which can be used as an ingredient or part of another food product, with a pH at or below about 6.4, or at or below about pH 7.1, or preferably at or below pH 7.5.

In preferred embodiments to maintain total polyphenol levels, procyanidin levels, particular flavan-3-ol compound levels, and/or the effective antioxidant levels (ORAC) of the one of more ingredients or additives selected or used, the method of producing a baked food product comprises maintaining the pH of the pre-baked mixture, or batter, at or below pH 6.8, or below about pH 7.0, or below about pH 6.7, or below about pH 6.6, or below about pH 6.5, or below about pH 6.3. In addition, the methods specifically include maintaining the pH at or below these levels after the point at which antioxidants, flavanols, flavan-3-ols, cocoa extracts, cocoa powder, and/or a cocoa-containing product or extract is added to a mixture, batter, or composition. Furthermore, the invention includes a baked food product or final product having a pH at or below pH 7.8, or below about pH 7.5, or at or below pH 7.2, below about pH 7.0, or below about pH 6.7, or below about pH 6.6, or below about pH 6.5, or below about pH 6.3, and further maintaining the pH to substantially the same level over time, for example, the average shelf life of a baked food product. As one of skill in the art appreciates, pH levels can be measured at room temperature and, for example, by diluting a sample of the batter or the final product with 9 parts water by volume and measuring the pH of the diluents using a commercial pH meter. Other methods are available to one of skill in the art and can be used. In another aspect or embodiment, the invention includes baked food products made from the methods to maintain polyphenols or antioxidants, as noted above and throughout. In more particular aspects, the methods of the invention comprise methods of preserving or maintaining levels of specific flavanol or antioxidant compounds and mixtures thereof in food products and the food products themselves. For example, levels of any one or more of the following groups of compounds or individual compounds or isomers of them can be preserved through the methods of the invention and tested for content before and after baking or processing into a food product: flavan-3-ol monomers; flavan-3-ol polymers; subsets of flavan-3-ol polymers of any desired range of unit lengths, such as up to 5 units in length or from 6 to 10 units in length; epicatechins; -(-)epicatechin; catechins; (+)-catechin; flavandiols; oligomers of flavandiols; leucocyanidins; quercetin; trans-resveratrol; epigallocatechin (EGC); epigallocatechin gallate (EGCG); (−)-epicatechin gallate; procyanidins; and oligomeric procyanidins. Thus, specific combinations of monomers and polymers can be selected, and specific flavan-3-ol monomer plus polymers levels, for example, can be selected, such as levels of flavan-3-ol monomer combined with polymers up to five (5) units or flavan-3-ol pentamers. In addition, methods to preserve a specific percentage of the initial flavanols, flavan-3-ols, and/or antioxidants present in an ingredient or combination of ingredients can be made and used according to the invention, such that, for example, 75% of cocoa polyphenols are preserved, or 75% of flavan-3-ol monomers combined with polymers up to five (5) units, or 75% of catechins combined with epicatechins. The percentage or range of percentages chosen can vary and can include from at least about 35%, to 40%, or 50%, or 60%, or 70%, or 80%, or 90% or higher amounts of compounds or combination preserved or maintained compared to the levels in the starting ingredient(s).

In another aspect, the invention comprises mixes and/or dried baking compositions, and baking kits comprising them, which are designed to be mixed with water or liquid ingredients, and optionally other ingredients, and are capable of being used to produce a baked food product. In one example, these mixtures can be a dried cake or brownie mixture, and preferred examples include, cakes, chocolate cakes, and chocolate brownies. The ingredients are selected to maintain a particularly desired pH when the water or liquid ingredients are added to the mix. For example, a mix comprising flour, flavoring agents, and a leavening agent can be combined so that the components of the leavening agent, for example, maintains a pH below a desired level or within a desired range. Thus, a mix comprising flour, sweetener, salt, and 3 parts baking powder to 1 part baking soda capable of generating a batter with pH of about 6.6 is specifically included in the invention. In addition, acids and acid salts can be used to buffer the batter to a desired range of pH, such as citric acid and/or citrates.

In another aspect, the invention includes the use of fruit purees, fruit juices, or fruit products to maintain the pH of the batter or final product. A particularly preferred example is the use of apple puree, however, many other fruits or vegetables can be selected, especially those known to have pH lower than about 7.5.

Any of the mixes, compositions, batters, kits, or methods of the invention, as well as any embodiment of the invention disclosed here, can employ edible or nutritional additives or extracts, for example additives that contain polyphenols, procyanidins, and/or antioxidants. Furthermore, preservatives, coloring agents, sweeteners, sugar, spices, and any other food or baking ingredients can be combined with these or any of the embodiments of the invention. Also, in any embodiment or method, various heating or baking conditions as known in the art can be employed, including typical cake-baking conditions of about 300 to 400 degrees F., more preferably about 350 degrees F.

Throughout this disclosure, applicants refer to journal articles, patent documents, published references, web pages, and other sources of information. One skilled in the art can use the entire contents of any of the cited sources of information to make and use aspects of this invention. Each and every cited source of information is specifically incorporated herein by reference in its entirety. For example, each of the articles listed here can be used to select methods for identifying and quantifying polyphenols, specific polyphenols and polymers, and ORAC levels: Cao, G. et al., Free Radic. Biol. Med. 14:303-311 (1993); Kelm, M. A, et al., Clin Dev. Immunol. 12: 35-41 (2005); Lazarus, S. A. et al., J. Agric. Food Chem. 47:3639-3701 (1999); Alonso Borbalan, A.M. et al., J. Chromatogr. A. 1012:31-38 (2003); Cao, G. et al., Clin. Chem. 44:1309-1315 (1998). Portions of any of the articles or sources listed in this document may be included in this document as allowed or required. However, the meaning of any term or phrase specifically defined or explained in this disclosure shall not be modified by the content of any of the articles or sources. The description and examples that follow are merely exemplary of the scope of this invention and content of this disclosure and do not limit the scope of the invention. In fact, one skilled in the art can devise and construct numerous modifications to the examples listed below without departing from the scope of this invention.

### BRIEF DESCRIPTION OF THE DRAWINGS

FIGS. 1-7 graphically depict the results represented by the data and tables discussed below. Various Baking Powder to Baking Soda amounts and combinations are tested and the results given. ORAC refers to Oxygen Radical Absorbance Capacity, as know in the art; TP refers to Total Polyphenols; Sum n=l thru 5 refers to the combined level of polyphenol monomers plus polymers up to polymers of 5 units; and Sum N=6 thru 10 refers to the combined level of polyphenol polymers of six units through ten units.

FIG. 1 depicts the antioxidant levels measured from cake products prepared and baked with different ratios of the leavening agents baking powder and baking soda. ORAC (oxygen radical absorbance capacity) is measured as umoles Trolox equivalents per gram (TE/gm).

FIG. 2 depicts the total polyphenols (TP) measured as gallic acid equivalents (GAE) per gram from cake products prepared and baked using the same ratios of leavening agents shown in FIG. 1.

FIG. 3 depicts the Total Monomers (here flavanol monomers) measured from cake products prepared and baked using the same ratios of leavening agents shown in FIG. 1.

FIG. 4 depicts the total procyanidins measured from cake products prepared and baked using the same ratios of leavening agents shown in FIG. 1

FIG. 5 depicts the pH of exemplary final baked, cake products having different ratios of leavening agents as shown in FIG. 1.

FIG. 6 depicts the levels of the combined polyphenol compounds from monomer to pentamer (sum n=l thru 5) of cake products having different ratios of leavening agents as shown in FIG. 1.

FIG. 7 depicts the levels of the combined polyphenol compounds from hexamer to decamer (sum n=6 thru 10) of cake products having different ratios of leavening agents as shown in FIG. 1.

FIGS. 8-10 depicts graphs showing the particular effects of pH levels on the concentration of various polyphenol compounds and groups of compounds after a cocoa-containing sample, such as a cake or baking mix containing cocoa powder, is contacted with ingredients that effect pH in a baked food product.

FIG. 8 depicts the level of total polyphenols measured when the pH of a final product (cake) containing cocoa is changed.

FIG. 9 depicts the level of flavan-3-ol monomers measured when the pH of a final product (cake) containing cocoa is changed.

FIG. 10 depicts the level of total procyanidins measured when the pH of a final product (cake) containing cocoa is changed.

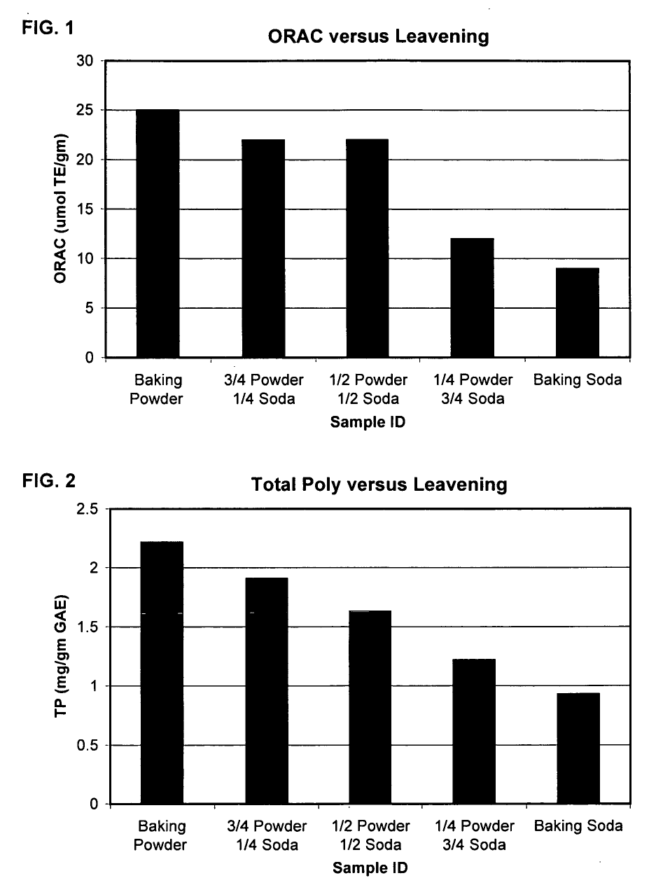

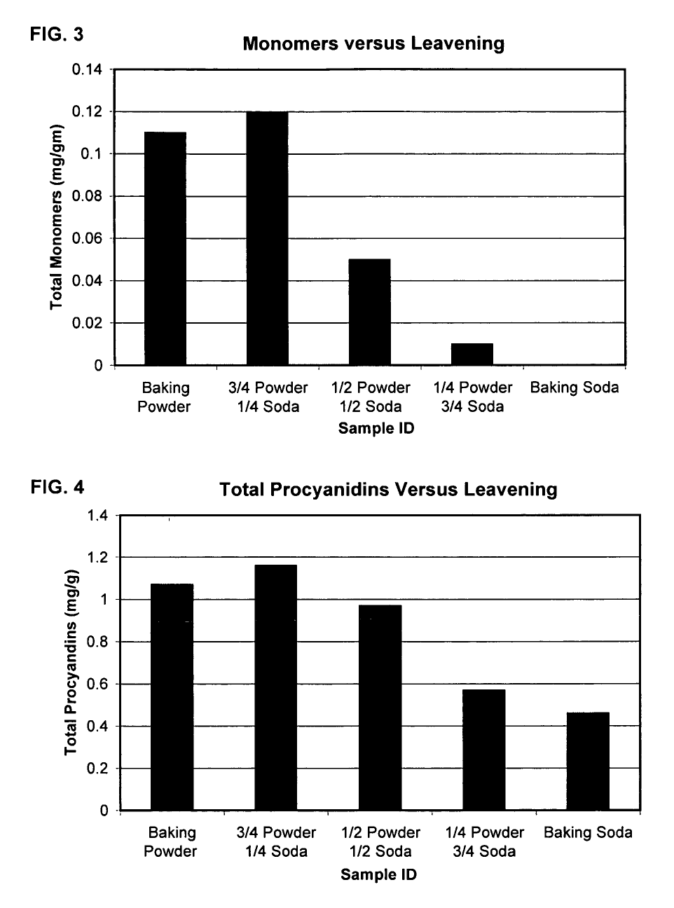

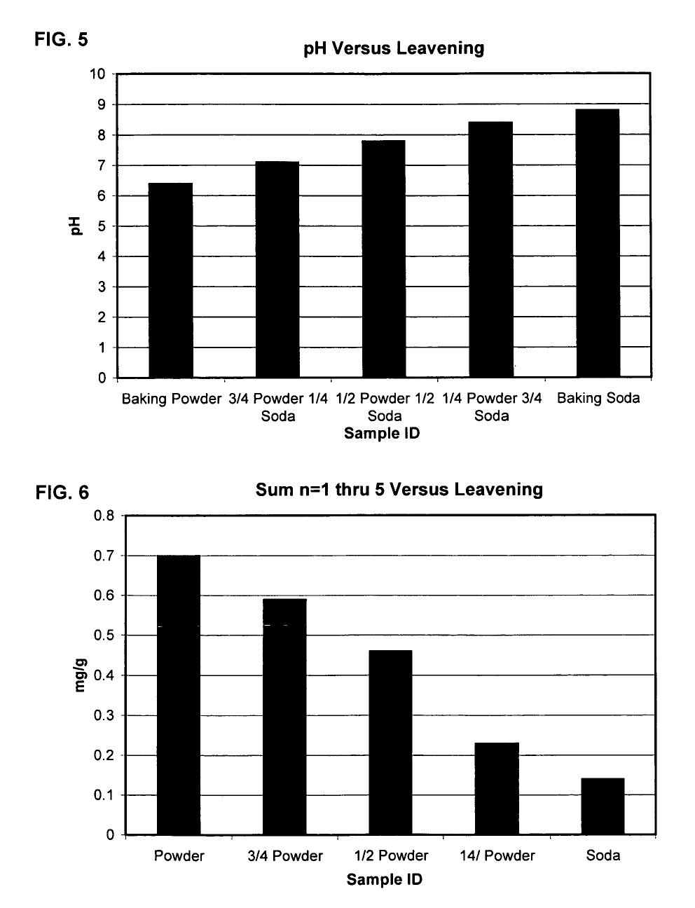

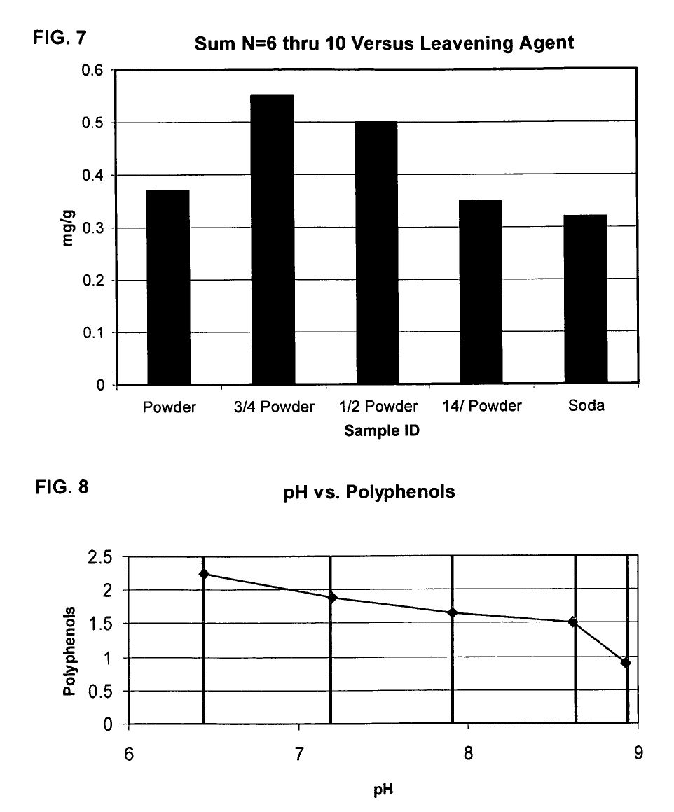

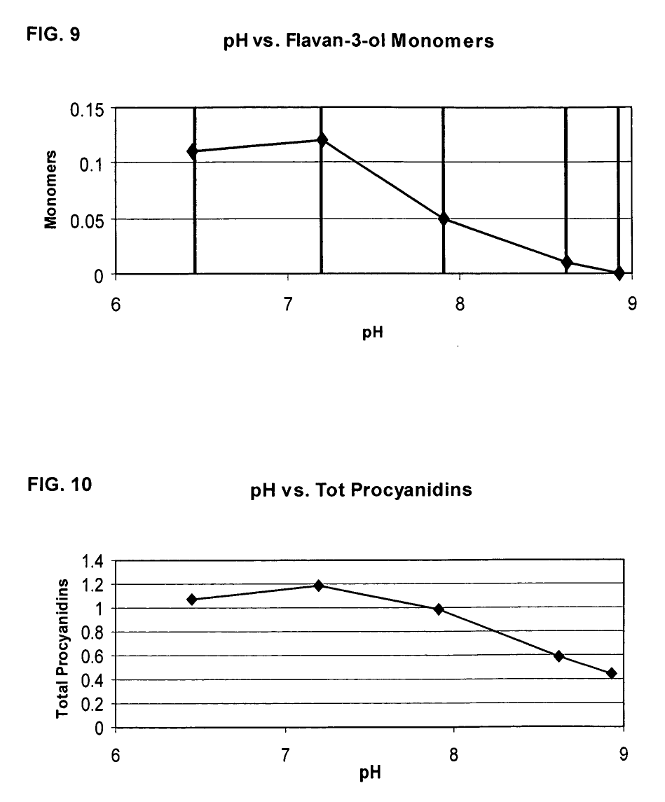

### DETAILED DESCRIPTION OF EXEMPLARY EMBODIMENTS

During the process of investigating the amount of flavanol antioxidants found naturally in cocoa powder, the inventors determined that not all cooked or baked products retain the same level of antioxidant activity. In comparing chocolate/cocoa-flavored hot cocoa, icings, brownies and cakes, it was found that hot cocoa and icings largely retained their antioxidant activities during preparation. This is contrary to the situation of green tea, as noted above. Surprisingly however, baked cakes had only about half the level of antioxidants compared to the unbaked batter. This finding is represented in the data of Table 1.

TABLE 1
Antioxidant and flavanol recovery from recipes

| | | Tot | | |
|---|---|---|---|---|
| | ORAC | Polyphenols | Flavanols | |
| Recipe | (% remain) | (% remain) | (% remain) | |
| Hot cocoa | 37 (89%) | 2.9 (100%) | 0.13 | (75%) |
| Icing | 79 (100%) | 6.1 (100%) | 0.40 | (100%) |
| Brownies | 62 (98%) | 4.6 (92%) | 0.28 | (100%) |
| Cake | 15 (55%) | 1.2 (43%) | <0.05 | (**) |

(**) Below detection limits
Tot Polyphenols = Total Polyphenols
ORAC = Oxygen Radical Absorbance Capacity

The effect of baking temperature can also be determined. As shown in Table 2, temperature itself is not a cause of the flavanol loss.

TABLE 2
Impact of Baking Temperature on Polyphenol Content

| | | Tot | | |
|---|---|---|---|---|
| | ORAC | Polyphenols | Flavanols | |
| Recipe | (% remain) | (% remain) | (% remain) | |
| Cake | | | | |
| 250 deg | 20 (65%) | 1.7 (54%) | <0.05 | (**) |
| 300 deg | 21 (67%) | 1.8 (55%) | <0.05 | (**) |
| 350 deg | 21 (67%) | 1.9 (58%) | <0.05 | (**) |
| Brownies | | | | |
| 250 deg | 62 (98%) | 4.6 (92%) | 0.26 | (96%) |
| 300 deg | 62 (98%) | 4.6 (92%) | 0.28 | (103%) |
| 350 deg | 62 (98%) | 4.5 (91%) | 0.24 | (89%) |

(**) Below detection limits

It was initially hypothesized that the brownies had a minimal loss of polyphenols because they contained both semisweet chocolate and cocoa, while the cake contained only cocoa. The baking chips, or the sugar or other ingredients, may serve as a polyphenol protectant. However, experimental studies in Table 3 indicate that the semisweet chocolate plays no role in the preservation of polyphenol content.

TABLE 3
Effect of Semisweet Baking Chips

| | | Tot | | |
|---|---|---|---|---|
| | ORAC | Polyphenols | Flavanols | |
| Recipe | (% remain) | (% remain) | (% remain) | |
| Chips | 47 (94%) | 23.8 (93%) | 0.2 | (>100%) |
| No Chips | 41 (98%) | 3.1 (89%) | <0.1 | (***) |

(***) limit of quantitation

Continuing to look at the effect of ingredients, we surprisingly found that if one uses baking soda as the sole leavening agent, the loss of flavanols is highest. Baking soda is typically used in baked chocolate goods to provide rapid leavening, and baking soda is by far the most commonly used and the primary leavening agent used in baking today. Replacing baking soda with baking powder, however, reduces the detectable loss of flavanols. The results in Table 4 look at the pH levels from using baking powder versus baking soda, and for combinations of them. There is an inverse correlation between the pH and the detectable flavanol in the baked product such that those products having a higher pH in the pre-baking stage had lower flavanol levels. In the process of baking the test food products and/or cakes, we also note by casual observation with the eye that the 100% baking soda cakes had noticeably darker color. The cakes were measured for color using a Hunter Colorimeter and its the L scale (=lightness scale with larger values indicating lighter color and lower numbers indicating darker color; black equal to zero). The color of a cake baked with 100% baking soda has the darkest color, the 100% baking powder cakes have the lightest color, and a systematic change in color resulted with different proportions of baking soda and baking powder (Table 4).

TABLE 4
pH of Final Cake Product and Color
of Chocolate Cakes with Baking Soda

| % Baking Soda | % Baking Powder | pH | Hunter Color (L) |
|---|---|---|---|
| 100% | 0% | 8.93 | 14.3 |
| 75% | 25% | 8.62 | 16.0 |
| 50% | 50% | 7.91 | 17.2 |
| 25% | 75% | 7.20 | 19.2 |
| 0% | 100% | 6.40 | 21.7 |

In preferred embodiments of the baked food products of the invention, the pH of the final cake product is kept below 7.5. In other preferred embodiments, the pH is kept at or below about pH 7.0. The use of baking soda, or use of too much baking soda, can cause an increase of the pH in the pre-baked batter, which results in the darkening of the cake and significant loss of the flavanols. Baked products using baking soda are found to have a darker color and milder flavor when compared to baked products with either commercial or custom made baking powder.

Thus, to avoid the loss of flavanols, the methods of the invention use leavening agents that keep the pH of the final cake at or below about 7.5 or at or below about pH 7.0 during the time the cocoa flavanols are present. To do this, combinations of baking soda blended with baking powder and other pH modifying substances can be selected. The invention specifically includes a method to select a leavening agent for a particular baked food product, mix for baking, and a composition comprising the selected leavening agent that is capable of being baked into a food product or ingredient.

In making and using aspects and embodiments of this invention, one skilled in the art may employ conventional baking techniques. Exemplary techniques are explained fully in the literature and are well known in the art. For example, one may rely on the following general texts to make and use the invention: Labensky, et. al., Webster's New World Dictionary of Culinary Arts; Food Chemistry, L. H. Meyer, Litton Educational Publishing, Inc., reprinted 1975 by AVI Publishing Inc., Westport, Conn.; Joy of Cooking; The Science of Baking, Chemical Leavening, American Institute of Baking, 1979, revised 1990; Dubois, D., Chemical Leavening, American Institute of Baking, Research Department Technical Bulletin, September 1981. Methods, ingredients, and combinations from these sources can be relied upon and incorporated herein to make and use aspects of the invention. However, no part of these texts should be taken as a limitation or alteration in any term or aspect of the invention specifically defined herein.

As used herein, a “cake” describes a broad range of pastries, including layer cakes, coffee cakes and gateaux. It can refer to any baked food product that is tender, sweet, and/or sometimes frosted. A “gateaux” describes any cake-type dessert, especially pastry items made with puff pastry, eclair paste, short dough or sweet dough. The term “baking powder” as used herein refers to various food-grade mixtures used as leavening agents in baking, consisting of baking soda, starch or a similar carrier, and one or more acidic compounds. “Leavening” as used herein is a process to introduce a gas or air into dough or batter and the gas or air can be produced by evolving from a reaction of ingredients in the batter or dough. The final product can be “set,” for example with heating, so that the dough supports itself structurally without the help of the entrapped gas. A “leavening acid” as used herein refers to a dry powder, which when dissolved in water releases acid to react with sodium bicarbonate to produce carbon dioxide leavening gas. “Baking soda” refers to sodium bicarbonate (NaHCO3), a white crystalline compound that is slightly alkaline and commonly used in baking. The “neutralizing value” as used herein refers to the parts by weight of sodium bicarbonate that 100 parts by weight of leavening acid will neutralize, i.e., react completely with and result in a near neutral pH. Other common acids and their neutralizing values are: monocalcium phosphate (80); sodium acid pyrophosphate (72-75); sodium aluminum sulfate (104); and sodium aluminum phosphate (100). Natural acids can also be used in food products and as a source of acid, such as flour, cocoa, tartaric acid, malic acid, succinic acid, citric acid, acetic acid, or any other acid, cream of tartar, fruit, fruit juices, fruit purees, fruit extracts, processed fruit, honey, sour milk, buttermilk, and vinegar. “Objective Effects” refer to measurement of product characteristics with instruments e.g., volume, weight, specific volume and pH. “Subjective Effects” refer to measurement of product characteristics by sight, touch, smell, odor or taste. “Rate of reaction” refers to a measure of how rapidly the leavening agent is releasing carbon dioxide or gas in a dough or batter.

Chemical leavening offers the advantage of taking much less time than yeast to raise the dough or batter to its desired consistency, or level or incorporated gas or air. Chemically leavened products can be baked immediately after the dough or batter are mixed and formed. Therefore, they have found extensive use in commercial baking applications and pre-packaged “mixes” of consumer baking products.

The two most common types of chemical leavening gases are carbon dioxide and ammonia. Generally, the leavening gases are produced by one of two methods: (1) heat decomposition of ammonium bicarbonate or ammonium carbonate; or (2) by a reaction of a leavening acid with sodium bicarbonate.

In the first method, ammonium carbonate begins to convert slowly into carbon dioxide, ammonia and water as soon as it is mixed. However, when the baking temperature reaches about 104 degrees F., the ammonium bicarbonate decomposes rapidly, greatly increasing the leavening effect. Because ammonia has an unpleasant odor and taste, it is generally used in low moisture products, which allow most of the ammonia to be driven off in the baking process. Ammonia also greatly increases the pH of the product, which produces more “browning” during the baking process, but returns the baked product to neutral when the ammonia escapes. Browning is considered an important and desirable subjective effect in cakes, especially chocolate cakes. Crumb pH affects the crumb color of baked products. The crumb becomes lighter in color as the pH is reduced down to about 7. For chocolate cakes, a pH of about 9 is generally a target to achieve the desired color and taste. However, as described earlier, increased pH has been found to be the major factor in the destruction of polyphenols, particularly flavonoids and flavan-3-ols, during the mixing into a batter and baking processes. Therefore, it is a further objective of the invention to describe a method for achieving the desirable subjective effects found in chocolate cakes (leavening, browning) while maintaining the pH of the pre-baked or batter mixture below about pH 6.8 or at or below about pH 6.6, and/or maintaining the final product or baked product pH at or below about pH 7.5. In another object, the invention includes maintaining a pH at or below a certain level through the mixing and baking process and/or after the point at which cocoa flavanols or beneficial antioxidants are added or used, as additives or as part of one or more ingredients.

In the second common method of chemical leavening, an acid powder dissolves and reacts with sodium bicarbonate (NaHCO3; baking soda) to produce carbon dioxide leavening gas. Moisture and heat are present to complete the reaction:
HX+NaHCO3→NaX+H2O+CO2

Of particular interest to the present invention, the leavening acid also neutralizes the alkalinity of the sodium bicarbonate. The amount of baking soda needed to produce a given product depends on the type of product to be produced. Cakes generally require about 0.5-1.0% baking soda (dry basis) to produce the desired consistency. Too much baking soda or any leavening agent in batter, such as cake batter, can cause the product to collapse while baking.

During baking, most of the carbon dioxide must be released before the product reaches the temperature at which the starch in the product gelatinizes. When the starch gels, it becomes rigid, and the product can no longer expand. If the leavening rate is too fast, there is a tendency to get a course cell structure, or even pronounced collapsing of the individual cells. If the rate is too slow, a smaller volume may result or structural rupturing or cracking may occur. Generally, the slowest leavener that will still avoid cracking or rupturing will produce the largest product volume.

Baking powder is a mixture of an acid-reacting material (leavening acid), sodium bicarbonate (baking soda) and a diluent. When the baking powder is mixed in a batter with the wet ingredients, the dry acid and the baking soda can then react together and release carbon dioxide. There are several different types of baking powders.

Single-acting baking powders are characterized by the type of acid they include. Tartrate baking powders contain both cream of tartar (potassium acid tartrate) and tartaric acid. These create gas quickly when combined with baking soda in the presence of liquid, so the batter must be cooked quickly or it will go flat.

S.A.S. baking powders have Sodium Aluminum Sulfate (alum) as the acid. S.A.S. baking powders react slowly at room temperature and release more of the gas when heated. The tartrate baking powders react rapidly at room temperature to release the leavening gas, which means that the batter has to be cooked quickly after the liquid ingredients have been added. On the other hand, the S.A.S. baking powders are better for products that will sit a while before being cooked.

The balancing of the acid salt against the baking soda can be important, since this balance is a major factor in determining the final pH of the bakery product. In many bakery foods, the pH is a major factor in determining the crumb color of the food. For example, the best crumb color and taste in chocolate cakes is obtained by adjusting the leavening to produce a final cake pH of 8 to 9. This requires an excess of soda in the formulation. As shown in the data of Tables 4 and 5, formulations containing greater amounts of baking powder than baking soda are required to prevent the degradation of flavanoids in cocoa.

The concept of Neutralizing Value (NV) was developed in the baking industry as a means for comparing the available acidity (CO2 releasing power) of various leavening acids. More importantly, NV is used to calculate the correct usage level. Generally, the leavening acid and soda are used in proportions so that very little of either one remains after baking. This results in the finished product being near neutral in pH. The neutralizing value is defined as the parts by weight of sodium bicarbonate from which 100 parts by weight of leavening acid will release all of the available CO2, i.e. will achieve complete neutralization.

S.A.S. and tartaric acid have very high neutralizing values when compared with other types of commercial leavening acids. Leavening acids with high neutralizing values such as these compounds are particularly effective in maintaining pH at values closer to neutral during the baking process, as used in the invention for preservation of the polyphenol products in chocolate.

While this disclosure and the examples refer in particular to chocolate and cocoa-containing containg products or ingredients, the invention is not limited to chocolate and cocoa products. In fact, any food product that is made under conditions where polyphenols or antioxidants are susceptible to degradation could benefit from the invention and the methods disclosed here. For example, cakes and other baked products or baked goods made with tea polyphenols, blueberries, cranberries, wine polyphenols, grapes, grape seed, spices and other polyphenolic compounds listed in the USDA Flavanoid databases or otherwise known or available in the art.

For the cocoa-containing food products, we refer generally to cocoa powder as cocoa solids with a total of about 10% to 12% fat, where the fat is generally cocoa butter. Other forms of cocoa, cocoa-containing products or ingredients can be used, for example: breakfast cocoa is cocoa solids with 20 to 24% fat, where the fat is generally cocoa butter; and chocolate liquor (or cocoa liquor) is ground cocoa nibs and it can be separated into cocoa butter and cocoa solids. The terms chocolate, milk chocolate, semisweet chocolate, bittersweet chocolate, and dark chocolate, are as used commonly in the U.S. food industry and do not imply, unless stated otherwise any particular composition.

As noted in the following examples, various compounds can be measured to design an optimum baked food product, ingredient, baking mix, or be used in a method to make a baked food product and maintain pH levels of the batter and/or baked product stages, or maintain various beneficial compounds. For example, each of total polyphenols, catechin, epicatechin, polyphenol monomers, polyphenol dimers or other specific polyphenol polymer(s), and ORAC can all be tested and used to select a particularly advantageous combination. A number of similar assays can also be used to determine the level of particular flavan-3-ol compounds and particularly monomer compounds, for example, and/or the total antioxidants present using one or more of total antioxidant capacity (TAC), TEAC (Trolox equivalent antioxidant capacity), TRAP (Total radical-trapping antioxidant parameter) assay, FRAP (Ferric-reducing ability of plasma) assay, and ABTS (2,2′-azine-bis-(3-ethylbenzthiazoline-6-sulfonic acid) and DPPH (2,2′-(4-tert-octylphenyl)-1-picrylhydraazyl)) radical scavenging assays, and other assays available in the art. In addition or in the alternative, the final food product or baked food product or ingredient can be selected based upon the color, the degree of rise from the leavening agent or other gas-introducing process, the taste, and the mouthfeel. One of skill in the art is familiar with methods for testing and recording each of these.

### EXEMPLARY EMBODIMENTS

The following examples show the utility and advantages of the invention, but should not be taken as a limit to, and are not intended to limit or confine, the scope or extent of the invention. Obviously, the amounts and measurements given are merely exemplary and one of skill in the art can modify the amounts within the ratios given or understood in the art to produce larger, or even smaller, batches for any embodiment.

### Example 1

A baked cake containing cocoa and using a greater quantity of baking powder than baking soda in order to maintain pH of the cake batter at 6.8 or below can be made according to the following:

| Ingredient | Weight % |
|---|---|
| Flour | 30 |
| Sucrose | 43 |
| Shortening | 12.4 |
| Baking Powder | 1 |
| Baking Soda | 0.1 |
| Nonfat Milk Solids | 3 |
| Dry whole egg | 3.6 |
| Salt | 0.9 |
| Cocoa Powder | 6 |

These ingredients can be mixed into a pre-baked mixture with water and the pH monitored by sampling prior to adding cocoa powder. After the pH is adjusted, to for example a pH of 6.6, or at or below 7.0, if necessary, the pre-baked batter is poured into a form and baked at 375 degrees F. for about 30 minutes, or until firm throughout. The baked food product will have a pleasant texture, dark color, and a good chocolate flavor.

In similar embodiments, about 75% or more of the total polyphenols are preserved during the method or in the final baked product, or about 80% or more, or about 90% or more, or about 95% or more. In addition, the ratio of baking powder to baking soda used can vary from about 3:1 to about 10:1 in preferred embodiments. In other embodiments, baking soda can be eliminated from the method or not used as one of the ingredients.

Results of one exemplary and representative baking study are shown below.

TABLE 5
% Cocoa Antioxidant Activity Remaining

| Leavening Agent | pH | ORAC | Total Poly | Monomers | Procyanidins |
|---|---|---|---|---|---|
| Baking Powder | 6.4 | 36 | 43 | 70 | 46 |
| ¾ Powder ¼ Soda | 7.1 | 31 | 37 | 80 | 50 |
| ½ Powder ½ Soda | 7.8 | 31 | 31 | 35 | 42 |
| ¼ Powder ¾ Soda | 8.4 | 17 | 23 | 7 | 24 |
| Baking Soda | 8.8 | 13 | 18 | 0 | 21 |

The numerical values above in Table 5 are the % of Cocoa antioxidant activity remaining after baking or in a final product or baked product. ORAC (Oxygen Radical Absorbance Capacity) is a measure of antioxidant activity. “Total Poly” is total polyphenols that can be measured using Folin method as an approximation of the total polyphenolic compounds present. “Monomers” refers to level of flavan-3-ol compounds, such as catechin and epicathechin, which can be measured using HPLC, for example. “Procyanidins” refers to the polymeric polyphenol compounds present, which again can be measured by HPLC. These data show that while the baking process itself does cause some loss when measured by several of the measurements, more important to the preservation of polyphenols is maintaining the pH, for example by selecting an appropriate leavening agent.

TABLE 6
Sample data showing levels of measured compounds.

| | | Total | | | | | | |
|---|---|---|---|---|---|---|---|---|
| | ORAC | Polyphen | | | Monomer | Total | | |
| | umole/ | mg(GAE)/ | Catechin | Epicatechin | Sum | Procyan | Cake | Batter |
| Sample ID | TE gram | gram | mg/g | mg/g | mg/g | mg/g | pH | pH |
| Baking | 25 | 2.22 | 0.03 | 0.08 | 0.11 | 1.07 | 6.4 | 6.35 |
| Powder | | | | | | | | |
| ¾ Powder | 22 | 1.91 | 0.04 | 0.08 | 0.12 | 1.16 | 7.1 | 6.59 |
| ¼ Soda | | | | | | | | |
| ½ Powder | 22 | 1.63 | 0.02 | 0.03 | 0.05 | 0.97 | 7.8 | 6.74 |
| ½ Soda | | | | | | | | |
| ¼ Powder | 12 | 1.22 | ND | 0.01 | 0.01 | 0.57 | 8.4 | 7.21 |
| ¾ Soda | | | | | | | | |
| Baking Soda | 9 | 0.93 | ND | ND | ND | 0.46 | 8.8 | 7.47 |
| Cocoa | 606 | 45.07 | 0.5 | 0.93 | 1.43 | 20.42 | | |

The levels of polyphenols for various pH of the final food product (listed above as “pH”) or ingredient, and the pH of the batter (“Batter pH”) show that as the pH rises, the levels of polyphenols decrease. Thus, one can select a pH to optimize the levels of polyphenols maintained during the mixing of the batter and the baking process. As shown in Table 6, the final or cake pH of 6.4 and the batter pH of 6.35 is optimum. This indicates that lowering the pH throughout the process can be beneficial to maintaining antioxidant levels in prepared and baked food products.

### Example 2

In a process for testing the preservation of total polyphenols during the mixing of ingredients into a batter and baking into a baked food product, a chocolate cake recipe can be used: ¾ cup butter or margarine, softened; 1-¾ cups sugar; 2 eggs; 1 teaspoon vanilla extract; 2 cups all-purpose flour; ¾ cup HERSHEY'S® Cocoa; ½ teaspoon salt; 1-⅓ cups water.

These ingredients are mixed with one or more leavening agents and the batter tested for pH in water and the final, baked product tested for pH, and the baked product tested for polyphenol content.

Similarly, additives with polyphenols or antioxidants can be used, for example: 4 eggs; 1-¾ cup flour; 1-½ cup sugar; ¾ cup butter; 2 Tbsps maccha powder (green tea powder); 1 Tbsp chocolate chips; baked at about 350 F (about 175 C) for 35 minutes. Other additives that can be selected and used, alone or in any combination, are spices, herbs, botanicals, botanical extracts, tea, tea extracts, fruits in their natural state or as extracts, including fruit purees, fruit juices, and other processed forms of fruits.

Alternatively, a baking mix can be used, for example: 1 cup sugar; 3 tablespoons unsweetened cocoa powder; 1-½ cups all-purpose flour; ½ teaspoon salt; and leavening agent, such as ½ teaspoon each baking powder and baking soda. A pH buffering agent, such as dried citric acid, can be added to maintain pH below a desired point when mixing batter. Other dried flavoring agents, such a crystalline vanillin or spray-dried vanilla, can be used. This mixture can be stored and then mixed with ⅓ cup vegetable shortening, water, and egg product, such as whole eggs, and then baked to produce a food product.

A baked cake containing cocoa and using baking powder containing leavening acids with a high Neutralizing Value that will react with the required quantity of sodium bicarbonate to produce sufficient rising but maintain the pH of the cake batter at or below 6.6, or below 7.5 for the baked cake, can be made. Any of the leavening acids, natural acids, of other agents listed above or known or available to one of skill in the art can be used.

### Example 3

As noted, fruit and vegetable products and extracts can be used. An applesauce or apple puree example includes the following:

| Ingredient | Grams |
|---|---|
| Flour | 222.35 |
| Sugar/Sucrose | 426.6 |
| Vegetable Oil | 62.15 |
| Baking Powder | 13.53 |
| Whole egg | 105.76 |
| Salt | 6.42 |
| Cocoa Powder | 65.89 |
| Buttermilk | 247.68 |
| Coffee(dry crystals) | 231.03 |
| Applesauce | 62.52 |
| Vanilla Extract | 5.20 |

The presence of applesauce maintains a lower pH, in this example a Batter pH of 6.17 and a final product or Cake pH of 5.78. These antioxidant preserving conditions maintain levels of beneficial antioxidants in the final product, as shown in the results below.

TABLE 7
Sample data for fruit puree or applesauce example.

| | Total Polyphenols | ORAC | Monomers | Procyanidins |
|---|---|---|---|---|
| | (mg(GAE)/gram) | umole TE/gram | mg/g | mg/g |
| Batter | 2.46 | 31 | .07 | 0.57 |
| Cake | 2.47 | 33 | .12 | 0.70 |

These results, which are not corrected for moisture, indicate excellent preservation of polyphenols, flavan-3-ols, and antioxidants.

The examples presented above and the contents of the application define and describe examples of the many food products, baked products, and methods for producing food products according to the invention. None of the examples and no part of the description should be taken as a limitation on the scope of the invention as a whole or of meaning of the following claims.

What is claimed is:

1. A method of making a baked food product that comprises at least one cocoa-containing ingredient, the method comprising mixing ingredients and maintaining the pH of the batter below about 6.8 after the point at which at least one cocoa-containing ingredient is added, and baking the mixed ingredients to produce a baked food product having a pH at or below pH 7.5.

2. The method of claim 1, wherein the pH of the baked food product is maintained below 7.0.

3. The method of claim 1, wherein the pH of the final food product is maintained below 6.8.

4. The method of claim 1, wherein the pH of the batter is maintained at or below about 6.6.

5. The method of claim 1, wherein the baked food product further comprises flour, a leavening agent, and at least one sweetener.

6. The method of claim 1, wherein the cocoa-containing ingredient is selected from one or more of: cocoa extracts containing flavanols, cocoa powder, dutched cocoa powder, baking chocolate, chocolate liquor, alkali-treated chocolate liquor, semisweet chocolate, bittersweet chocolate, and milk chocolate.

7. The method of claim 6, wherein the cocoa-containing ingredient is semisweet chocolate.

8. The method of claim 6, wherein the cocoa-containing ingredient is cocoa powder.

9. The method of claim 2, wherein the cocoa-containing ingredient is selected from one or more of: cocoa extracts containing flavanols, cocoa powder, dutched cocoa powder, baking chocolate, chocolate liquor, alkali-treated chocolate liquor, semisweet chocolate, bittersweet chocolate, and milk chocolate.

10. The method of claim 4, wherein the cocoa-containing ingredient is selected from one or more of: cocoa extracts containing flavanols, cocoa powder, dutched cocoa powder, baking chocolate, chocolate liquor, alkali-treated chocolate liquor, semisweet chocolate, bittersweet chocolate, and milk chocolate.

11. The method of claim 1, further comprising adding at least one leavening agent.

12. The method of claim 11, wherein the at least one leavening agent comprises baking soda and baking powder.

13. The method of claim 4, further comprising adding at least one leavening agent.

14. The method of claim 13, wherein the at least one leavening agent comprises baking soda and baking powder.

15. The method of claim 1, further comprising monitoring the pH of the mixed ingredients prior to baking.

16. A baked food product produced by the method of claim 1, wherein the food product has a pH of about 7.1 or below.

17. A baked food product produced by the method of claim 2, wherein the food product has a pH of about 7.1 or below.

18. A baked food product produced by the method of claim 3, wherein the food product has a pH of about 7.1 or below.

19. A baked food product produced by the method of claim 4, wherein the food product has a pH of about 7.1 or below.

20. A food product comprising cocoa or chocolate, wherein the content of polyphenol compounds present in a cocoa extract containing flavanols, cocoa ingredient, chocolate ingredient, or other ingredient or additive is preserved to about 75% or above of the total level present in the ingredient or additive by maintaining a pH below 7.5 in the final food product.

21. The method of claim 20, wherein the food product is a baking mix comprising flour and at least one leavening agent and the final food product is a baked product.

22. The food product of claim 21, further comprising sucrose or bulk sweetener.

23. The food product of claim 20, wherein a cocoa ingredient is selected from one or more of: cocoa extracts containing flavanols, cocoa powder, dutched cocoa powder, chocolate liquor, alkali-treated chocolate liquor, semisweet chocolate, bittersweet chocolate, and milk chocolate.

24. The food product of claim 21, wherein a cocoa ingredient is selected from one or more of: cocoa extracts containing flavanols, cocoa powder, dutched cocoa powder, chocolate liquor, alkali-treated chocolate liquor, semisweet chocolate, bittersweet chocolate, and milk chocolate.

25. A method of preserving the total polyphenol content present in one or more ingredients of a baked food product comprising mixing baking powder and baking soda at a ratio of between about 3:1 to about 10:1, adding other ingredients including one or more ingredients comprising edible polyphenols, and baking the mixed ingredients.

26. The method of claim 25, wherein the one or more ingredients comprising edible polyphenols is selected from one or more of: cocoa extracts containing flavanols, cocoa powder, dutched cocoa powder, chocolate liquor, alkali-treated chocolate liquor, semisweet chocolate, bittersweet chocolate, and milk chocolate.

27. A chocolate cake or chocolate food product produced by the method of claim 26.

28. A method of preserving the total polyphenol content present in one or more ingredients of a baked food product comprising mixing the ingredients and maintaining a pH at or below 6.8, and baking the ingredients to maintain a baked product at or below pH 7.5.

29. The method of claim 28, wherein the pH of the baked product is maintained below about 7.0.

30. The method of claim 28, wherein the pH or pre-baked mixed ingredients is maintained at or below about 6.6.

31. A method of preserving the total procyanidin content present in one or more ingredients of a baked food product comprising mixing the ingredients and maintaining a pH below 6.8, and baking the ingredients to maintain a baked product at or below pH 7.5.

32. The method of claim 31, wherein the pH of the baked product is maintained below about 7.0.

33. The method of claim 31, wherein the pH of pre-baked mixed ingredients is maintained at or below about 6.6.

34. A method of preserving the content of flavan-3-ol monomer plus polymers up to flavan-3-ol pentamer present in one or more ingredients of a baked food product, comprising mixing the ingredients and maintaining a pH below 6.8, and baking the ingredients to maintain a baked product at or below pH 7.5.

35. The method of claim 34, wherein the pH of the baked product is maintained below about 7.0.

36. The method of claim 36, wherein the pH of pre-baked mixed ingredients is maintained at or below about 6.6.

37. A method of preserving the content of flavan-3-ol polymers of unit length 6 to 10 present in one or more ingredients of a baked food product, comprising mixing the ingredients and maintaining a pH below 6.8, and baking the ingredients to maintain a baked product at or below pH 7.5.

38. The method of claim 37, wherein the pH of the baked product is maintained below about 7.0.

39. The method of claim 37, wherein the pH of pre-baked mixed ingredients is maintained at or below about 6.6.

40. A method of preserving the epicatechin and/or catechin content present in one or more ingredients of a baked food product, comprising mixing the ingredients and maintaining a pH below 6.8, and baking the ingredients to maintain a baked product at or below pH 7.5.

41. The method of claim 40, wherein the pH of the baked product is maintained below about 7.0.

42. The method of claim 40, wherein the pH of the pre-baked mixed ingredients is maintained below about 6.6.

43. A method of preserving the epicatechin content present in one or more ingredients of a baked food product comprising mixing the ingredients and maintaining a pH below 6.8, and baking the ingredients to maintain a baked product at or below pH 7.5.

44. The method of claim 43, wherein the pH of the baked product is maintained below about 7.0.

45. The method of claim 43, wherein the pH of the pre-baked mixed ingredients is maintained below about 6.6.

46. A method of producing a baked food product comprising adding to a cocoa-containing pre-baked batter an amount of fruit puree or extract sufficient to lower the pH to about 7.0 or below, and baking the pre-baked mixture to produce a final baked product having a pH at or below pH 7.5.

47. The method of claim 46, wherein the fruit puree is applesauce.

48. The method of claim 46, wherein the pH of the pre-baked mixture is at or below pH 6.8.

49. The method of claim 46, wherein the pH of the pre-baked mixture is at or below pH 6.6.

50. A baking mix comprising a cocoa-containing product, one or more leavening agents, and one or more sweeteners, wherein the baking mix is designed to be mixed with a milk product, an egg product, and a fruit puree to produce a pre-baked batter, and wherein the pre-baked batter has a pH of about 7.0 or below.

51. The baking mix of claim 50, wherein the fruit puree is applesauce.

52. The baking mix of claim 50, wherein the milk product is buttermilk.

53. The baking mix of claim 50, wherein the cocoa-containing product is cocoa powder.

54. The baking mix of claim 51, wherein the cocoa-containing product is cocoa powder.

55. The baking mix of claim 50, wherein the egg product is whole eggs.

56. The baking mix of claim 50, wherein the pre-baked batter has a pH of at or below pH 6.8.

57. The baking mix of claim 50, wherein the pre-baked batter has a pH of at or below pH 6.6.
